(19) United States
(12) Patent Application Publication
(10) Pub. No.: US 2024/0343291 A1
(43) Pub. Date: Oct. 17, 2024

(54) METHOD OF CONTROLLING OPERATION OF DUAL INTEGRATED CONTROL APPARATUS FOR AUTONOMOUS VEHICLES

(71) Applicants: Hyundai Motor Company, Seoul (KR); Kia Corporation, Seoul (KR); SL Corporation, Daegu (KR)

(72) Inventors: Jae Wan CHO, Seoul (KR); Won Jin Jeong, Hwaseong-Si (KR); Chun Nyung Heo, Gyeongsan-Si (KR); Gwang Sun Kim, Gyeongsan-Si (KR); Yong Woo Park, Gyeongsan-Si (KR); Jae Hoon Jung, Gyeongsan-Si (KR); Seok Woo Ye, Daegu (KR); Mi Rae Do, Gyeongsan-Si (KR)

(73) Assignees: Hyundai Motor Company, Seoul (KR); Kia Corporation, Seoul (KR); SL Corporation, Daegu (KR)

(21) Appl. No.: 18/375,097

(22) Filed: Sep. 29, 2023

(30) Foreign Application Priority Data
Apr. 17, 2023 (KR) 10-2023-0050091

(51) Int. Cl. B62D 1/12; B60K 26/02; B60W 50/16; B60W 60/00; B62D 15/02

(52) U.S. Cl. CPC B62D 1/12; B60K 26/021; B60W 50/16; B60W 60/0053; B62D 15/029; B60K 2026/022

(57) ABSTRACT

A method of controlling operation of an integrated control apparatus for autonomous vehicles includes setting one joystick lever touched first by a user between a first joystick lever and a second joystick lever to a function activation state, or setting any one joystick lever with a larger steering operation force to the function activation state at the time of steering the first joystick lever and the second joystick lever together. User fatigue when operating the joystick levers is reduced.

### CROSS-REFERENCE TO RELATED APPLICATION

The present application claims priority to Korean Patent Application No. 10-2023-0050091, filed on Apr. 17, 2023, the entire contents of which is incorporated herein for all purposes by this reference.

### BACKGROUND OF THE PRESENT DISCLOSURE

### Field of the Present Disclosure

The present disclosure relates to a method of controlling operation of a dual integrated control apparatus for autonomous vehicles, and more particularly, to a method of controlling operation of a dual joystick lever provided in an autonomous vehicle.

### Description of Related Art

Autonomous vehicles are smart vehicles incorporating self-driving technology that allows a vehicle to travel and find a destination by itself without a driver directly operating a steering wheel, an accelerator pedal, a brake, and the like.

When a general autonomous driving situation is realized, it is possible to select a manual driving mode in which a driver directly drives a vehicle and an autonomous driving mode in which a vehicle travels to a destination by itself without a driver directly driving the vehicle.

Meanwhile, if an emergency occurs during autonomous driving, one of passengers of the vehicle must manually operate the vehicle. To the present end, a device operated by a user for a manual driving mode needs to be provided in the vehicle.

For example, there are cases where a vehicle manager operates a vehicle in a manual driving mode using a device such as a joystick used in game consoles or the like.

A device operated by a user to drive a vehicle in the manual driving mode is provided with a plurality of switches operated for acceleration, braking, steering, and shifting of the vehicle, and thus the device may be called an integrated control device because it has a plurality of switches having different functions.

The matters described as the related art above are only for improving understanding of the background of the present disclosure, and should not be taken as an admission that they correspond to related art already known to those skilled in the art.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control method for, in a configuration in which an autonomous vehicle is provided with two joystick levers, setting one joystick lever touched first by a user to a function activation state when the user touches the two joystick levers, and setting any one joystick lever with a large steering operation force to the function activation state during steering operation, to allow the user to more easily recognize the joystick lever in the function activation state, reducing the user fatigue when operating the joystick levers.

In accordance with various exemplary embodiments of the present disclosure, the above and other objects may be accomplished by the provision of a method of controlling operation of an integrated control apparatus for autonomous vehicles, the method including a gripping step in which a user grips a first joystick lever and a second joystick lever provided in an autonomous vehicle with both hands, respectively, and a setting step of determining a priorly recognized touch sensor between a touch sensor provided in the first joystick lever and a touch sensor provided in the second joystick lever, setting a lever including the priorly recognized touch sensor to a function activation state among the first and second joystick levers, and setting the other lever to a function inactivation state among the first and second joystick levers.

The method may further include an information display step of transmitting information on the first joystick lever or the second joystick lever set to the function activation state to the user using at least one of a lever LED, a haptic motor, or a display.

The method may further include a first determination step of determining whether one or more individual sensors in the touch sensor provided in the first joystick lever maintain touch recognition if the first joystick lever is set to the function activation state and the second joystick lever is set to the function inactivation state through the setting step, and a first change step of changing the first joystick lever to the function inactivation state upon determining that one or more individual sensors in the first joystick lever do not maintain touch recognition as a result of the determining in the first determination step.

A control logic may be fed back to the information display step upon determining that one or more individual sensors in the first joystick lever maintain touch recognition as a result of the determining in the first determination step.

The method may further include a second determination step of determining whether one or more individual sensors in the touch sensor provided in the second joystick lever recognize a touch after the first change step, wherein, upon concluding that one or more individual sensors in the second joystick lever recognize a touch as a result of determining in the second determination step, the second joystick lever is changed to the function activation state and the first joystick lever is maintained in the function inactivation state.

The control logic may be fed back to the first change step upon concluding that one or more individual sensors in the second joystick lever do not recognize a touch as a result of the determining in the second determination step.

The method may further include a third determination step of determining whether one or more individual sensors in the touch sensor provided in the second joystick lever maintain touch recognition if the second joystick lever is set to the function activation state and the first joystick lever is set to the function inactivation state through the setting step, and a second change step of changing the second joystick lever to the function inactivation state upon concluding that one or more individual sensors in the second joystick lever do not maintain touch recognition as a result of the determining in the third determination step.

The control logic may be fed back to the information display step upon determining that one or more individual sensors in the second joystick lever maintain touch recognition as a result of determination in the third determination step.

The method may further include a fourth determination step of determining whether one or more individual sensors in the touch sensor provided in the first joystick lever recognize a touch after the second change step, wherein, upon determining that one or more individual sensors in the first joystick lever recognize a touch as a result of determination in the fourth determination step, the first joystick lever is changed to the function activation state and the second joystick lever is maintained in the function inactivation state.

Upon determining that one or more individual sensors in the first joystick lever do not recognize a touch as a result of determination in the fourth determination step, the control logic may be fed back to the second change step.

A lever set to the function inactivation state between the first joystick lever and the second joystick lever may be configured to follow or not follow operation of a lever set to the function activation state.

In accordance with various exemplary embodiments of the present disclosure, a method of controlling operation of an integrated control apparatus for autonomous vehicles includes a gripping step in which a user grips a first joystick lever and a second joystick lever provided in an autonomous vehicle with both hands, respectively, a comparison step of comparing a steering operation force of the first joystick lever with a steering operation force of the second joystick lever when a user performs steering operation using the first joystick lever and the second joystick lever together, and a final step of setting a lever including a relatively large steering operation force between the first joystick lever and the second joystick lever to a function activation state and setting the other lever to a function inactivation state.

The method may further include a setting step of determining a priorly recognized touch sensor between a touch sensor provided in the first joystick lever and a touch sensor provided in the second joystick lever, setting a lever including the priorly recognized touch sensor to the function activation state, and setting the other lever to the function inactivation state before the comparison step.

The method may further include an information display step of transmitting information on the first joystick lever or the second joystick lever set to the function activation state through the setting step to a driver using at least one of a lever LED, a haptic motor, or a display.

The steering operation force of the first joystick lever and the steering operation force of the second joystick lever may be measured by respective torque sensors, measured values may be transmitted to a main PCB, and the main PCB may be configured to determine magnitudes of the steering operation forces.

The main PCB may compare absolute values of the values measured by the respective torque sensors to determine the magnitudes of the steering operation forces regardless of a steering operation direction of the first joystick lever and a steering operation direction of the second joystick lever.

Upon determining that the steering operation force of the first joystick lever is greater than the steering operation force of the second joystick lever as a result of determination in the comparison step, the first joystick lever may be set to the function activation state and the second joystick lever may be set to the function inactivation state in the final step.

Upon determining that the steering operation force of the second joystick lever is greater than the steering operation force of the first joystick lever as a result of determination in the comparison step, the second joystick lever may be set to the function activation state and the first joystick lever may be set to the function inactivation state in the final step.

A lever set to the function inactivation state through the final step may be configured to follow or not follow operation of a lever set to the function activation state.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of dual integrated control apparatuses each including a joystick levers provided in an autonomous vehicle according to an exemplary embodiment of the present disclosure;

FIG. 2 is a diagram for describing a joystick lever;

FIG. 3 is an exploded view of the joystick lever;

FIG. 4 is a block diagram schematically illustrating the configuration of an integrated control apparatus according to an exemplary embodiment of the present disclosure;

FIG. 5, FIG. 6 and FIG. 7 are diagrams for describing a function activation state, a function inactivation flexible state, and a function inactivation fixed state of the joystick lever according to an exemplary embodiment of the present disclosure; and

FIG. 8 and FIG. 9 are flowcharts of various exemplary embodiments for describing a control method according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, but a same or similar components are denoted by a same reference numerals and redundant descriptions thereof will be omitted.

The suffixes “module” and “part” of elements herein are used for convenience of description and thus may be used interchangeably and do not have any distinguishable meanings or functions.

In the following description of the exemplary embodiments included in the present specification, a detailed description of known functions and configurations incorporated herein will be omitted when it may obscure the subject matter of the present disclosure.

Furthermore, the accompanying drawings are provided only for ease of understanding of the exemplary embodiments included in the present specification, do not limit the technical spirit included herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component.

When a component is “directly coupled” or “directly connected” to another component, it should be understood that no element is present between the two components.

An element described in the singular form is directed to include a plurality of elements unless the context clearly indicates otherwise.

In the present specification, it will be further understood that the term “comprise” or “include” specifies the presence of a stated feature, figure, step, operation, component, portion or combination thereof, but does not preclude the presence or addition of one or more other features, figures, steps, operations, components, or combinations thereof.

Furthermore, a unit or a control unit included in the names of a motor control unit (MCU), a hybrid control unit (HCU), and the like is only a term widely used to name a controller that is configured to control a specific vehicle function and does not mean a generic functional unit.

A controller may include a communication device that communicates with other controllers or sensors to control functions of the controller, a memory that stores an operating system or logic commands and input/output information, and one or more processors that perform determination, operation, and decision necessary to control the functions.

Hereinafter, an integrated control apparatus for autonomous vehicles and a method of controlling operation thereof according to exemplary embodiments of the present disclosure will be described with reference to the accompanying drawings.

An autonomous vehicle is provided with an integrated control apparatus through which a user (manager) can directly drive the vehicle in a manual driving mode.

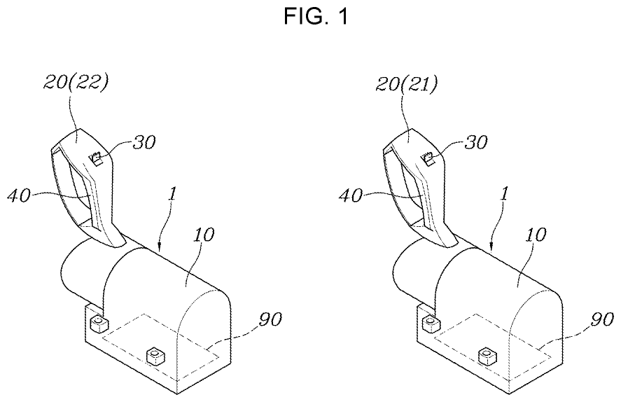

As illustrated in FIGS. 1 to 7, the integrated control apparatus 1 according to an exemplary embodiment of the present disclosure includes a main body 10 forming the external body including a housing, and a joystick lever 20 rotatably coupled to the main body 10 and hand-operated by a driver.

The integrated control apparatus 1 including the main body 10 and the joystick lever 20 may be dually provided in an autonomous vehicle, any one of the integrated control apparatuses may be provided on the right side of a user or the driver's seat inside the vehicle so that the user can easily operate the same with their right hand, and the other integrated control apparatus may be provided on the left side of the user or the driver's seat inside the vehicle so that the user can easily operate the same with their left hand.

When the integrated control apparatus 1 is provided in an autonomous vehicle, the main body 10 may be fixed to a designated position inside the vehicle so that it is not moved, and may be moved to a position desired by the user as needed.

Each integrated control apparatus 1 includes one main body 10, and each main body 10 includes one joystick lever 20.

The joystick levers 20 provided in respective main bodies 10 may be referred to as a first joystick lever 21 and a second joystick lever 22, and in an exemplary embodiment of the present disclosure, the right lever is described the first joystick lever 21 and the left lever is referred to as the second joystick lever 22.

The integrated control apparatus 1 may include a toggle switch 30, a touch sensor 40, a lever printed circuit board (PCB) 50, and a lever light-emitting diode (LED) 60, a haptic motor 70, and a prism 80 provided in the joystick lever 20, and a main PCB 90 provided in the main body 10.

After gripping the joystick lever 20 by hand, the user can operate the joystick lever 20 by rotating the entire joystick lever 20 with respect to the main body 10 in the forward-and-backward direction and in the left-and-right direction thereof.

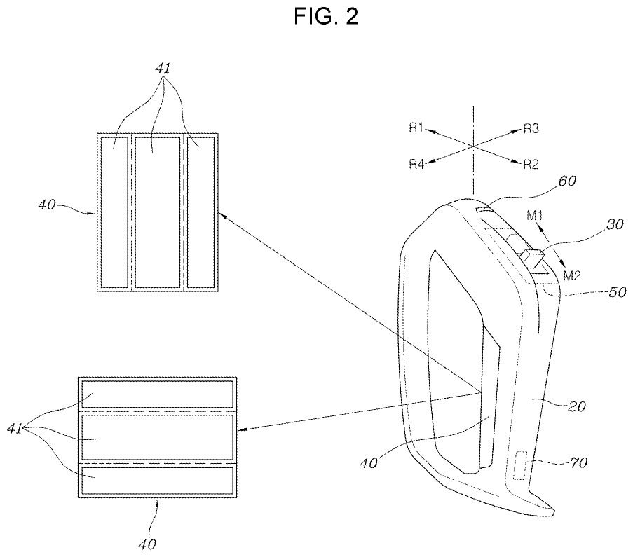

The main PCB 90 generates a signal related to acceleration of the vehicle when the user rotates the joystick lever 20 forward while gripping the joystick lever 20 by hand (direction R1 in FIG. 2) and generates a signal related to deceleration of the vehicle when the user rotates the joystick backward (direction R2 in FIG. 2).

Furthermore, if the user rotates the joystick lever 20 to the right or left (direction R3 or R4 in FIG. 2) while gripping the joystick lever 20 by hand, the main PCB 90 generates a signal related to steering of the vehicle.

When the vehicle is accelerated or decelerated by operating the joystick lever 20, the speed of the vehicle is changed within a wide range, and accordingly rapid acceleration and rapid braking may be performed, and the speed may be changed within a wide range, for example, by 5 km/h or 10 km/h.

The joystick lever 20 is provided with the toggle switch 30 that the user can operate with a finger.

The toggle switch 30 may be configured in a form of a button.

The toggle switch 30 may be provided on the upper surface of the joystick lever 20 so that the user can operate the toggle switch 30 with the thumb of the hand gripping the joystick lever 20.

If the user pushes the toggle switch 30 forward to operate the same (direction M1 in FIG. 2), the main PCB 90 generates a signal related to acceleration of the vehicle, and if the user pulls the toggle switch 30 backward to operate the same (direction M2 in FIG. 2), the main PCB 90 generates a signal related to deceleration of the vehicle.

When the vehicle is accelerated or decelerated by operating the toggle switch 30, the speed of the vehicle is changed within a narrower range than when the speed is adjusted using the joystick lever 20, and thus the vehicle speed may be slowly increased or decreased during parking, stopping or U-turn, and the speed may be changed within a narrow range, for example, by 1 km/h.

The joystick lever 20 is provided with the touch sensor 40 configured for detecting the user gripping the joystick lever 02 by hand, that is, touching the joystick lever 20.

The touch sensor 40 is provided to be fixed to a grip portion of the joystick lever 20 gripped by a user's hand.

The touch sensor 40 may be, for example, a capacitive touch sensor, and may include a touch button that generates a physical signal when the user manipulates the same.

The touch sensor 40 may include an assembly of two or more individual sensors 41, and as an exemplary embodiment of the present disclosure, may include three individual sensors 41 as shown, but the number of individual sensors 41 may be adjusted as necessary.

As illustrated in FIG. 2, the two or more individual sensors 41 may be configured to be continuously disposed in the horizontal direction or continuously disposed in the vertical direction, and all individual sensors 41 may be in contact with the user's hand when the user grips the joystick lever 20.

The touch sensor 40 is protected by being covered by a cover 23 coupled to the joystick lever 20.

The lever PCB 50 is fixed to the joystick lever 20 via a bracket 51.

The lever PCB 50 may be fixed to the upper surface of the joystick lever 20, control operations of the lever LED 60 and the haptic motor 70, and transmit/receive signals to/from the main PCB 90.

If a manual driving mode signal is generated while the vehicle is traveling in an autonomous driving mode, the lever PCB 50 may be configured to generate a signal corresponding to the function activation state of the joystick lever 20 or generate a signal corresponding to the function inactivation state according to a situation (condition) in which the user touches the touch sensor 40.

The autonomous vehicle can select the manual driving mode in which a driver directly drives the vehicle or the autonomous driving mode in which the vehicle travels to a destination by itself without a driver directly driving the vehicle.

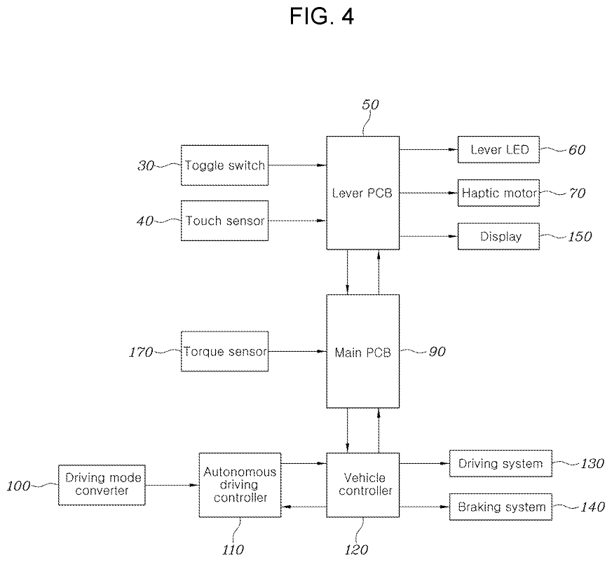

As illustrated in FIG. 4, the driver may select the autonomous driving mode or the manual driving mode of the vehicle by operating a driving mode converter 100.

The driving mode converter 100 may include a switch, a button, or a dial that generates an autonomous driving mode signal and a manual driving mode signal.

The driving mode converter 100 may be provided around the driver's seat for easy operation by a driver, and may be positioned on a seat in an autonomous vehicle as needed.

A signal from the driving mode converter 100 may be transmitted to an autonomous driving controller 110 of the vehicle, the autonomous driving controller 110 may send a control signal to a vehicle controller 120, and the vehicle controller 120 may transmit a control signal to a driving system 130 and a braking system 140 of the vehicle to accelerate or brake the vehicle.

The main PCB 90 and the vehicle controller 120 may transmit and receive signals.

The integrated control apparatus 1 according to an exemplary embodiment of the present disclosure may be in the function activation state or the function inactivation state according to a touch state (contact state) of the touch sensor 40 according to the user in a state in which the joystick lever 20 protrudes.

The function inactivation state may include a function inactivation flexible state and a function inactivation fixed state.

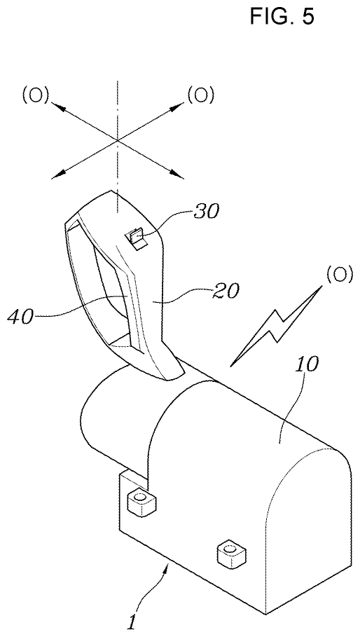

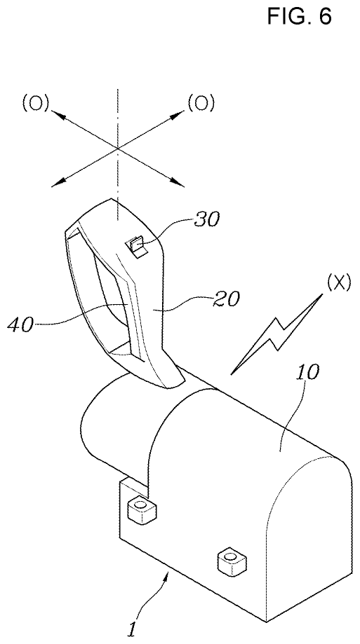

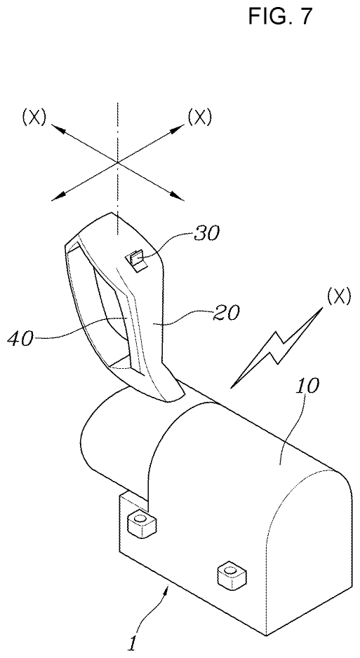

FIG. 5 illustrates the function activation state, and in the function activation state, the user can rotate the joystick lever 20 in the forward-and-backward direction and in the left-and-right direction, and a state (O) in which any one or more of a vehicle acceleration signal, deceleration signal, and steering signal are generated according to control of the main PCB 90 during operation of the joystick lever 20 may be defined.

The function activation state may be defined as an active mode or an active state.

FIG. 6 and FIG. 7 illustrates function inactive states, and FIG. 6 illustrates the function inactivation flexible state which may be defined as a state in which the joystick lever 20 may be rotated in the forward-and-backward direction and in the left-and-right direction (O), but a vehicle acceleration signal, deceleration signal, or steering signal is not generated (X) even if the user operates the joystick lever 20.

FIG. 7 illustrates the function inactivation fixed state which may be defined as a state in which the joystick lever 20 cannot be moved and thus cannot be operated, and a vehicle acceleration signal, deceleration signal, or steering signal is not generated because the joystick level 20 cannot be operated (X).

When the first joystick lever 21 and the second joystick lever 22 are provided in the vehicle, the driver can alternately operate the first joystick lever 21 and the second joystick lever 22 using a preferred hand between the left hand and the right hand to drive the vehicle and may use one hand for drinking while operating the joystick with the other hand.

Furthermore, when precise manipulation is required, such as when passing through an alleyway, the driver can manipulate the first joystick lever 21 and the second joystick lever 22 with both hands to perform precise steering operation.

Furthermore, when a large body motion such as rapid cornering occurs, the driver may set one of the first joystick lever 21 and the second joystick lever 22 to the function activated state to perform function operation with one hand, and maintain the other in the function inactivation fixed state so that it is configured as a support, and thus the driver can feel psychological stability.

When a manual driving mode signal is generated while the vehicle is traveling in the autonomous driving mode and the user grips the grip portion of the joystick lever 20, the lever PCB 50 generates a function activation state signal only when the user touches all the individual sensors 41 forming the touch sensor 40, and if the user does not touch any individual sensor 41, the level PCB 50 generates a function inactivation state signal.

Accordingly, when the driver or a passenger in the passenger seat unintentionally touches the joystick lever 20, activation of the joystick lever 20 may be prevented, improving driving safety.

The integrated control apparatus 1 according to an exemplary embodiment of the present disclosure further includes the lever LED 60 coupled to the joystick lever 20 and turned on or off according to control of the lever PCB 50.

The lever LED 60 may be electrically connected to the lever PCB 50 and fixed to the bracket 51.

The lever LED 60 is a component for allowing the user to easily visually recognize the function activation state of the joystick lever 20, and the lever LED 60 be turned on in the function activation state of the joystick lever 20 and turned off in the function deactivation state of the joystick lever 20.

The integrated control apparatus 1 according to an exemplary embodiment of the present disclosure further includes the prism 80 coupled to the joystick lever 20 and diffusing light generated from the lever LED 60.

Due to the light diffused through the prism 80, the user can more easily recognize that the joystick lever 20 is in the function activation state.

Furthermore, the integrated control apparatus 1 according to an exemplary embodiment of the present disclosure further includes the haptic motor 70 coupled to the joystick lever 20 and operated by control of the lever PCB 50 to generate a tactile signal.

The haptic motor 70 is a component for allowing the user to easily tactilely recognize that the joystick lever 20 is in the function activation state or the function inactivation state, and the haptic motor 70 may operate to generate different types of tactile signals in the function activation state and in the function inactivation state.

The haptic motor 70 may be configured to generate a tactile signal when the joystick lever 20 is in the function activation state and not to generate a tactile signal when the joystick lever 20 is in the function inactivation state, or may be configured not to generate a tactile signal when the joystick lever 20 is in the function activation state and to generate a tactile signal when the joystick lever 20 is in the function inactivation state.

Accordingly, the driver can easily recognize the function activation state or the function inactivation state of the joystick lever 20, which is helpful in preventing erroneous operation and improving driving safety.

The haptic motor 70 may be located in the grip portion of the joystick lever 20 gripped by the user so that the user can more reliably perceive the vibration of the haptic motor 70.

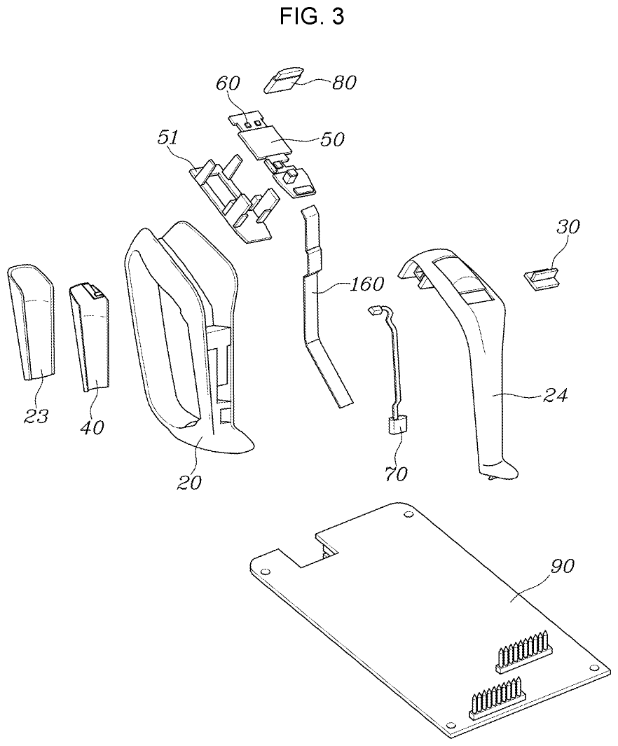

As illustrated in FIG. 3, the lever PCB 50 and the haptic motor 70 are electrically connected through a flexible cable 160, and the lever PCB 50, the lever LED 60, the haptic motor 70, and the like may be protected by being covered by the cover 24 coupled to the joystick lever 20.

The function activation state and the function inactivation state of the joystick lever 20 may be displayed on a display 150 of the vehicle under the control of the lever PCB 50, and thus the driver can more easily recognize the function activation state or the function inactivation state of the joystick lever 20.

Furthermore, the integrated control apparatus 1 according to an exemplary embodiment of the present disclosure further includes a torque sensor 170 configured for detecting an operating force when the user rotates the joystick lever 20 to the right or left to perform steering operation.

The torque sensor 170 includes a torsion bar which is twisted during steering operation of the joystick lever 20, a magnet and a Hall sensor configured for measuring a torsion amount of the torsion bar.

One torque sensor 170 may be provided for each integrated control apparatus 1 to individually measure the steering operation force of the first joystick lever 21 and the steering operation force of the second joystick lever 22, and the steering operation force of the first joystick lever 21 and the steering operation force of the second joystick lever 22 measured by the torque sensor 170 may be transmitted to the main PCB 90 so that the main PCB 90 can compare the magnitudes of the steering operation force of the first joystick lever 21 and the steering operation force of the second joystick lever 22.

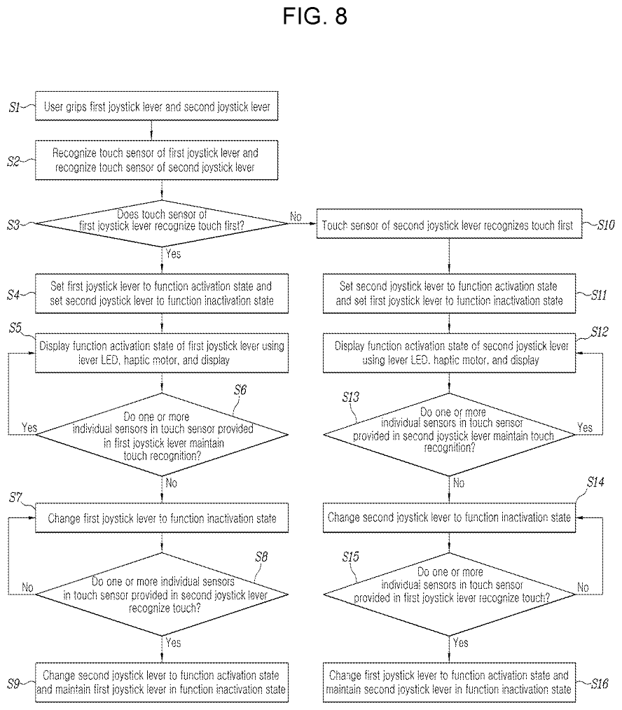

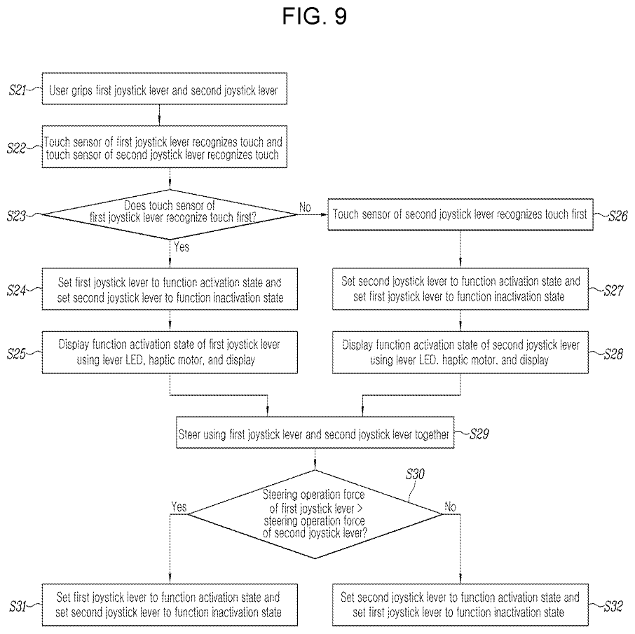

Hereinafter, a method of controlling operation of the integrated control apparatus for autonomous vehicles according to an exemplary embodiment of the present disclosure will be described with reference to FIG. 8 and FIG. 9.

FIG. 8 is a flowchart illustrating a control method of various exemplary embodiments according to an exemplary embodiment of the present disclosure.

In the control method of the various exemplary embodiments of the present disclosure, when a user touches the first joystick lever 21 and the second joystick lever 22 to operate the joystick lever 20, the lever touched first by the user is set to the function activation state, and the lever touched later by the user is set to the function inactivation state.

That is, the control method of the various exemplary embodiments includes a gripping step in which a user grips the first joystick lever 21 and the second joystick lever 22 provided in an autonomous vehicle with both hands of the user, respectively, and a setting step of determining a priorly recognized touch sensor between the touch sensor 40 provided in the first joystick lever 21 and the touch sensor 40 provided in the second joystick lever 22, setting the lever including the priorly recognized touch sensor to a function activation state, and setting the other lever to a function inactivation state.

To operate the joystick lever 20, the user grips the first joystick lever 21 and the second joystick lever 22 with both hands (step S1) which corresponds to the gripping step.

The user grips the grip portion of the first joystick lever 21 and the grip portion of the second joystick lever 22 with both hands, and at the instant time, the touch sensor 40 is provided in each grip portion of the lever to recognize a user's touch on the lever.

That is, the touch sensor 40 of the first joystick lever 21 recognizes a user's touch on the first joystick lever 21, and the touch sensor 40 of the second joystick lever 22 recognizes a user's touch on the second joystick lever 22 (step S2).

A signal of the touch sensor 40 of the first joystick lever 21 and a signal of the touch sensor 40 of the second joystick lever 22 are transmitted to the lever PCB 50, and the lever PCB 50 or the main PCB 90 is configured to determine whether the touch sensor 40 of the first joystick lever 21 or the touch sensor 40 of the second joystick lever 22 has been recognized first.

In step S3, it is determined whether the touch sensor 40 of the first joystick lever 21 has been recognized first, and if it is determined the touch sensor 40 of the first joystick lever 21 has been recognized prior to the touch sensor 40 of the second joystick lever 22, the first joystick lever 21 is set to the function activation state and the second joystick lever 22 is set to the function inactivation state through control (step S4).

Steps S3 and S4 correspond to the setting step.

In step S5, the function activation state of the first joystick lever 21 may be transmitted to the driver by being displayed on one or more devices among the lever LED 60, the haptic motor 70, and the display 150 under the control of the lever PCB 50, and thus the driver can easily recognize the lever in the function activated state, reducing the user fatigue when operating the joystick lever.

Step S5 corresponds to an information display step.

After step S5, a first determination step (step S6) of determining whether one or more individual sensors 41 in the touch sensor 40 provided in the first joystick lever 21 in the function activation state maintain touch recognition is executed.

After the first joystick lever 21 is set to the function activation state through step S4, the first joystick lever 21 continues to maintain the function activation state if any one of the individual sensors 41 of the touch sensor 40 provided in the first joystick lever 21 continues to recognize a touch.

That is, if it is determined that one or more individual sensors 41 maintain touch recognition in the first joystick lever 21 as a result of determination in the first determination step (step S6), a control logic of the present disclosure is fed back to the information display step (step S5) and continues to execute the logic.

However, if it is determined that one or more individual sensors 41 in the first joystick lever 21 do not maintain touch recognition as a result of determination in the first determination step (step S6), that is, if the driver releases their hand from the first joystick lever 21 and thus the touch sensor 40 of the first joystick lever 21 does not recognize a driver's touch, a first change step of changing the first joystick lever 21 to the function inactivation state through control (step S7) is executed.

In the first change step (step S7), both the first joystick lever 21 and the second joystick lever 22 maintain the function inactive state.

After the first change step (step S7), a second determination step (step S8) of determining whether one or more individual sensors 41 in the touch sensor 40 provided in the second joystick lever 22 recognize a touch is executed.

If it is determined that one or more individual sensors 41 in the second joystick lever 22 do not recognize a touch as a result of determination in the second determination step (step S8), the control logic of the present disclosure is fed back to the first change step (step S7).

However, if it is determined that one or more individual sensors 41 in the second joystick lever 22 recognize a touch as a result of determination in the second determination step (step S8), the second joystick lever 22 is changed to the function activation state, the first joystick lever 21 is maintained in the function inactive state, and the user operates the second joystick lever 22 in the function activation state to steer and accelerate or decelerate the vehicle (step S9).

If it is determined that the touch sensor 40 of the second joystick lever 22 has been recognized prior to the touch sensor 40 of the first joystick lever 21 as a result of determination in step S3 (step S10), the second joystick lever 22 is set to the function activation state and the first joystick lever 21 is set to the function inactivation state through control (step S11).

Steps S10 and S11 are also included in the setting step.

In step S12, the function activation state of the second joystick lever 22 is transmitted to the driver by being displayed on one or more devices among the lever LED 60, the haptic motor 70, and the display 150 under the control of the lever PCB 50, and thus the driver can easily recognize the lever in the function activation state, reducing the user fatigue when operating the joystick lever.

Step S12 is also included in the information display step.

After step S12, a third determination step (step S13) of determining whether one or more individual sensors 41 in the touch sensor 40 provided in the second joystick lever 22 in the function activation state maintain touch recognition is executed.

After the second joystick lever 22 is set to the function activation state through step S11, the second joystick lever 22 continues to maintain the function activation state if any one of the individual sensors 41 of the touch sensors 40 provided in the second joystick lever 22 continuously recognize a touch.

That is, if it is determined that one or more individual sensors 41 in the second joystick lever 22 maintain touch recognition as a result of determination in the third determination step (step S13), the control logic of the present disclosure is fed back to the information display step (step S12) and continues to execute the logic.

However, if it is determined that one or more individual sensors 41 in the second joystick lever 22 do not maintain touch recognition as a result of determination in the third determination step (step S13), that is, if the driver releases their hand from the second joystick lever 22 and thus the touch sensor 40 of the second joystick lever 22 does not recognize a driver's touch, a second change step of changing the second joystick lever 22 to the function inactive state through control (step S14) is executed.

In the second change step (step S14), both the first joystick lever 21 and the second joystick lever 22 are maintained in the function inactive state.

After the second change step (step S14), a fourth determination step (step S15) of determining whether one or more individual sensors 41 in the touch sensor 40 provided in the first joystick lever 21 recognize a touch is executed.

If it is determined that one or more individual sensors 41 in the first joystick lever 21 do not recognize a touch as a result of determination in the fourth determination step (step S15), the control logic of the present disclosure is fed back to the second change step (step S14).

However, if it is determined that one or more individual sensors 41 in the first joystick lever 21 recognize a touch as a result of determination in the fourth determination step (step S15), the first joystick lever 21 is changed to the function activation state and the second joystick lever 22 is maintained in the function inactive state through control, and the user operates the first joystick lever 21 in the function activation state to steer and accelerate or decelerate the vehicle (step S16).

In the exemplary embodiment of the present disclosure, a lever set to the function inactivation state between the first joystick lever 21 and the second joystick lever 22 may be configured to follow or not follow the operation of a lever set to the function activation state, and accordingly it is possible to satisfy various drivers including different preferences.

In the various exemplary embodiments according to an exemplary embodiment of the present disclosure, one of the first joystick lever 21 and the second joystick lever 22, which is touched first by a user, is set to the function activation state, and thus the user can easily recognize which of the first joystick lever 21 and the second joystick lever 22 is in the function activation state. The logic of the various exemplary embodiments is preferred by a driver who operates the joystick lever with one hand to steer and accelerate or decelerate the vehicle.

FIG. 9 is a flowchart illustrating a control method of various exemplary embodiments according to an exemplary embodiment of the present disclosure.

In the control method of the various exemplary embodiments of the present disclosure, when the user grips the first joystick lever 21 and the second joystick lever 22 with both hands to operate the joystick lever 20 and then performs steering operation, a lever including a relatively large steering operation force is set to the function activation state and the other lever including a relatively small steering operation force is set to the function inactivation state.

That is, the control method of the various exemplary embodiments includes a gripping step in which the user grips the first joystick lever 21 and the second joystick lever 22 provided in an autonomous vehicle with both hands, respectively, a comparison step of comparing a steering operation force of the first joystick lever 21 with a steering operation force of the second joystick lever 22 when the user performs steering using the first joystick lever 21 and the second joystick lever 22 together, and a final step of setting one of the first joystick lever 21 and the second joystick lever 21 including a relatively large steering operation force to the function activation state and setting the other lever to the function inactivation state.

To operate the joystick lever 20, the user grips the first joystick lever 21 and the second joystick lever 22 with both hands (step S21) which corresponds to the gripping step.

The user grips the grip portion of the first joystick lever 21 and the grip portion of the second joystick lever 22 with both hands, and at the instant time, the touch sensor 40 is provided in each grip portion of the lever to recognize a user's touch on the lever.

That is, the touch sensor 40 of the first joystick lever 21 recognizes a user's touch on the first joystick lever 21, and the touch sensor 40 of the second joystick lever 22 recognizes a user's touch on the second joystick lever 22 (step S22).

A signal of the touch sensor 40 of the first joystick lever 21 and a signal of the touch sensor 40 of the second joystick lever 22 are transmitted to the lever PCB 50, and the lever PCB 50 or the main PCB 90 is configured to determine whether the touch sensor 40 of the first joystick lever 21 or the touch sensor 40 of the second joystick lever 22 has been recognized first.

In step S23, it is determined whether the touch sensor 40 of the first joystick lever 21 has been recognized first, and if it is determined the touch sensor 40 of the first joystick lever 21 has been recognized prior to the touch sensor 40 of the second joystick lever 22, the first joystick lever 21 is set to the function activation state and the second joystick lever 22 is set to the function inactivation state through control (step S24).

Steps S23 and S24 correspond to the setting step.

That is, the setting step is logic which is executed before the comparison step is executed, and corresponds to a step of determining the touch sensor first recognized between the touch sensors 40 provided in the first joystick lever 21 and the touch sensor 40 provided in the second joystick lever 22, setting one lever including the priorly recognized touch sensor to the function activation state, and setting the other lever to the function inactivation state.

In step S25, the function activation state of the first joystick lever 21 may be transmitted to the driver by being displayed on one or more devices among the lever LED 60, the haptic motor 70, and the display 150 under the control of the lever PCB 50, and thus the driver can easily recognize the lever in the function activated state, reducing the user fatigue when operating the joystick lever.

Step S25 corresponds to an information display step.

If it is determined that the touch sensor 40 of the second joystick lever 22 has been recognized prior to the touch sensor 40 of the first joystick lever 21 (step S26), the second joystick lever 22 is set to the function activation state and the first joystick lever 21 is set to the function inactivation state (step S27).

Steps S26 and S27 are also included in the setting step.

In step S28, the function activation state of the second joystick lever 22 may be transmitted to the driver by being displayed on one or more devices among the lever LED 60, the haptic motor 70, and the display 150 under the control of the lever PCB 50, and thus the driver can easily recognize the lever in the function activated state, reducing the user fatigue when operating the joystick lever.

Step S28 is also included in the information display step.

After the first joystick lever 21 is set to the function activation state or the second joystick lever 22 is set to the function activation state through steps S24 and S27, the user may perform steering operation using the first joystick lever 21 and the second joystick lever 22 together (step S29).

When the user performs steering operation using the first joystick lever 21 and the second joystick lever 22 together through step S29, the steering operation force of the first joystick lever 21 and the steering operation force of the second joystick lever 22 are measured by the torque sensor 170, measured values of the torque sensor 170 are transmitted to the main PCB 90, and the main PCB 90 is configured to determine the magnitudes of the steering operation forces (step S30).

When the main PCB 90 determines the magnitudes of the steering operation forces of the first joystick lever 21 and the second joystick lever 22, the main PCB 90 compares the absolute values of the values measured by the torque sensor 170 to determine the magnitudes of the steering operation forces regardless of the steering operation direction of the first joystick lever 21 and the steering operation direction of the second joystick lever 22.

When a direction in which the joystick lever is rotated toward the user's body is set to an inward rotation direction and a direction in which the joystick lever is rotated outwardly from the user's body is set to an outward rotation direction, the main PCB 90 is configured to determine the magnitudes of the steering operation forces by comparing the absolute values of the values measured by the torque sensor 170 regardless of the inward rotation direction or the outward rotation direction of the first joystick lever 21 and the second joystick lever 22.

Step S30 corresponds to the comparison step.

If it is determined that the steering operation force of the first joystick lever 21 is greater than the steering operation force of the second joystick lever 22 as a result of the comparison step (step S30), the first joystick lever 21 is set to the function activation state and the second joystick lever 22 is set to the function inactivation state (step S31).

However, if it is determined that the steering operation force of the second joystick lever 22 is greater than the steering operation force of the first joystick lever 21 as a result of determination in the comparison step (step S30), the second joystick lever 22 is set to the function activation state and the first joystick lever 21 is set to the function inactivation state through control (step S32).

Steps S31 and S32 correspond to the final steps.

In the exemplary embodiment of the present disclosure, the lever set to the function inactivation state between the first joystick lever 21 and the second joystick lever 22 may be configured to follow or not follow the operation of the lever set to the function activation state, and accordingly it is possible to satisfy various drivers including different preferences.

In the various exemplary embodiments according to an exemplary embodiment of the present disclosure, at the time of steering using the first joystick lever 21 and the second joystick lever 22 together, a lever including a relatively large steering operation force is set to the function activation state, and the driver's intention is reflected in the lever during steering operation, reducing the user fatigue when operating the joystick lever.

As described above, according to an exemplary embodiment of the present disclosure, one of the first joystick lever 21 and the second joystick lever 22, which is touched first by the user, is set to the function activation state, and thus the user can easily recognize which of the first joystick lever 21 and the second joystick lever 22 is in the function activation state. The present embodiment is preferred by a user who operates the joystick lever with one hand to steer and accelerate or decelerate the vehicle.

Furthermore, according to an exemplary embodiment of the present disclosure, at the time of steering using the first joystick lever 21 and the second joystick lever 22 together, a lever including a relatively large steering operation force is set to the function activation state, and driver's intention is reflected in the lever during steering operation, reducing the user fatigue when operating the joystick lever.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling operation of an integrated control apparatus for an autonomous vehicle, the method comprising:
a gripping step of recognizing a user's gripping of a first joystick lever and a second joystick lever provided in the autonomous vehicle with both hands of the user, respectively; and
a setting step of determining a priorly recognized touch sensor between a touch sensor provided in the first joystick lever and a touch sensor provided in the second joystick lever, setting a lever including the priorly recognized touch sensor to a function activation state among the first and second joystick levers, and setting the other lever to a function inactivation state among the first and second joystick levers.

2. The method of claim 1, further including an information display step of transmitting information on the first joystick lever or the second joystick lever set to the function activation state to the user using at least one of a lever LED, a haptic motor, or a display.

3. The method of claim 2, further including:
a first determination step of determining whether one or more individual sensors in the touch sensor provided in the first joystick lever maintain touch recognition in response that the first joystick lever is set to the function activation state and the second joystick lever is set to the function inactivation state through the setting step; and
a first change step of changing the first joystick lever to the function inactivation state upon concluding that the one or more individual sensors in the first joystick lever do not maintain the touch recognition as a result of the determining in the first determination step.

4. The method of claim 3, wherein a control logic is fed back to the information display step upon concluding that the one or more individual sensors in the first joystick lever maintain the touch recognition as a result of the determining in the first determination step.

5. The method of claim 3, further including a second determination step of determining whether one or more individual sensors in the touch sensor provided in the second joystick lever recognize a touch after the first change step,
wherein, upon concluding that the one or more individual sensors in the second joystick lever recognize the touch as a result of the determining in the second determination step, the second joystick lever is changed to the function activation state and the first joystick lever is maintained in the function inactivation state.

6. The method of claim 5, wherein the control logic is fed back to the first change step upon concluding that the one or more individual sensors in the second joystick lever do not recognize the touch as a result of the determining in the second determination step.

7. The method of claim 1, further including:
a third determination step of determining whether one or more individual sensors in the touch sensor provided in the second joystick lever maintain touch recognition in response that the second joystick lever is set to the function activation state and the first joystick lever is set to the function inactivation state through the setting step; and
a second change step of changing the second joystick lever to the function inactivation state upon concluding that the one or more individual sensors in the second joystick lever do not maintain the touch recognition as a result of the determining in the third determination step.

8. The method of claim 7, wherein the control logic is fed back to the information display step upon concluding that the one or more individual sensors in the second joystick lever maintain the touch recognition as a result of the determining in the third determination step.

9. The method of claim 7, further including a fourth determination step of determining whether one or more individual sensors in the touch sensor provided in the first joystick lever recognize a touch after the second change step,
wherein, upon concluding that the one or more individual sensors in the first joystick lever recognize the touch as a result of the determining in the fourth determination step, the first joystick lever is changed to the function activation state and the second joystick lever is maintained in the function inactivation state.

10. The method of claim 9, wherein, upon concluding that the one or more individual sensors in the first joystick lever do not recognize the touch as a result of the determining in the fourth determination step, the control logic is fed back to the second change step.

11. The method of claim 1, wherein a lever set to the function inactivation state among the first and second joystick levers is configured to follow or not follow operation of a lever set to the function activation state among the first and second joystick levers.

12. A method of controlling operation of an integrated control apparatus for autonomous vehicles, the method comprising:
a gripping step of recognizing a user's gripping of a first joystick lever and a second joystick lever provided in an autonomous vehicle with both hands of the user, respectively;
a comparison step of comparing a steering operation force of the first joystick lever with a steering operation force of the second joystick lever in response that the user performs steering operation using the first joystick lever and the second joystick lever together; and
a final step of setting a lever including a relatively large steering operation force among the first and second joystick levers to a function activation state and setting the other lever among the first and second joystick levers to a function inactivation state.

13. The method of claim 12, further including a setting step of determining a priorly recognized touch sensor between a touch sensor provided in the first joystick lever and a touch sensor provided in the second joystick lever, setting a lever including the priorly recognized touch sensor to the function activation state among the first and second joystick levers, and setting the other lever to the function inactivation state among the first and second joystick levers before the comparison step.

14. The method of claim 13, further including an information display step of transmitting information on the first joystick lever or the second joystick lever set to the function activation state through the setting step to the user using at least one of a lever LED, a haptic motor, or a display.

15. The method of claim 12, wherein the steering operation force of the first joystick lever and the steering operation force of the second joystick lever are measured by respective torque sensors, measured values of the steering operation forces are transmitted to a main printed circuit board (PCB), and the main PCB is configured to determine magnitudes of the steering operation forces.

16. The method of claim 15, wherein the main PCB compares absolute values of the values measured by the respective torque sensors to determine the magnitudes of the steering operation forces regardless of a steering operation direction of the first joystick lever and a steering operation direction of the second joystick lever.

17. The method of claim 12, wherein, upon concluding that the steering operation force of the first joystick lever is greater than the steering operation force of the second joystick lever as a result of the determining in the comparison step, the first joystick lever is set to the function activation state and the second joystick lever is set to the function inactivation state in the final step.

18. The method of claim 12, wherein, upon concluding that the steering operation force of the second joystick lever is greater than the steering operation force of the first joystick lever as a result of the determining in the comparison step, the second joystick lever is set to the function activation state and the first joystick lever is set to the function inactivation state in the final step.

19. The method of claim 12, wherein a lever set to the function inactivation state among the first and second joystick levers through the final step is configured to follow or not follow operation of a lever set to the function activation state among the first and second joystick levers.
